(19) United States
(12) Patent Application Publication
(10) Pub. No.: US 2018/0060779 A1
(43) Pub. Date: Mar. 1, 2018

(54) METHOD OF GENERATING BUSINESS PROCESS MODEL AND COMPUTERIZED SYSTEM ASSOCIATED THEREWITH

(71) Applicant: Conduent Business Services, LLC, Dallas, TX (US)

(72) Inventors: Kunal Suri, Palaiseau (FR); Chunyang Xiao, Grenoble (FR); Adrian Corneliu Mos, Meylan (FR)

(73) Assignee: Conduent Business Services, LLC, Dallas, TX (US)

(21) Appl. No.: 15/245,346

(22) Filed: Aug. 24, 2016

(51) Int. Cl. G06Q 10/06; G06F 17/30; G06F 17/27

(52) U.S. Cl. CPC G06Q 10/06316; G06F 17/30554; G06F 17/2705; G06F 17/30867

(57) ABSTRACT

A method of generating a business process model includes receiving a description of a select business process in electronic form, processing the description of the select business process at the computerized system using a natural language processing algorithm to parse business activities from the description, searching a business concept repository using a search engine for existing business concept models related to each business activity parsed from the description, and displaying each existing business concept model resulting from the searching in a graphical representation for manipulation by a process designer using a business concept manipulation tool to form a specific business process model for the select business process. The select business process is associated with a domain-specific business type. A computerized system for designing and modeling business processes for use in business process management is also provided.

### BACKGROUND

This disclosure presents various embodiments of a method of generating a business process model. In several embodiments, the method is applied to generating a domain-specific business process model for use in business process management of a business enterprise. The method combines natural language processing (NLP), a business concept repository, a search engine, and a business concept manipulation tool to reuse existing business concept models to form a business process model for a select business process. Semantic rules tailored to the domain-specific business type can be implemented with the NPL, business concept repository, search engine, and business concept manipulation tool in various combinations. The disclosure also presents various embodiments of a computerized system configured to implement the method and a computer-readable medium storing program instructions that are associated with the method.

In classical business process management (BPM) frameworks, the processes designers use standardized languages, such as business process (BP) model and notation (BPMN), to design and visualize their processes. These processes are mostly designed using a graphical editor that understands BPMN. In general, these processes are designed with the aim of getting a better picture of what is done in an organization or business, to execute these processes in a BPM engine, to share the process information across various stakeholders, and for process documentation. When using BPMN, the users need to be familiar with many technical elements of the notation. However, even in the best of cases, there remains ambiguity in process design.

There have been some methods described in literature that make use of natural languages to create generic process models, mainly from the use case descriptions. For additional information on generic process models, see U.S. Pat. App. Publication No. 2011/0239183 to Paradkar et al., the contents of which are fully incorporated herein by reference. While some researchers have used text parsing on process description and designed a generic process from it, these research ideas are focused on generic processes and have not considered the use of semantic information that is present in a BP repository for a faster and efficient process design. For additional information on the use of text parsing for designing a generic process, see Frederick et al., Process Model Generation from Natural Language Text, Proceedings of the 23^{rd} International Conference on Advanced Information Systems Engineering (CAiSE′11), Springer-Verlag Berlin, Heidelberg, Jun. 20, 2011, pp. 482-496, the contents of which are fully incorporated herein by reference.

There are some gaps in the ongoing BPM research, as they do not exploit the power of business semantics. Thus, there is a need for improved techniques for designing and modeling BPs that include such considerations.

### BRIEF DESCRIPTION

In one aspect, a method of generating a business process model is provided. In one embodiment, the method includes receiving a description of a select business process in electronic form at a computerized system configured to design and model business processes for use in business process management, wherein the select business process is associated with a domain-specific business type; processing the description of the select business process at the computerized system using a natural language processing algorithm to parse one or more business activities from the description; searching a business concept repository in a storage device using a search engine for at least one existing business concept model related to each business activity of the one or more business activities parsed from the description, wherein the storage device is accessible to the computerized system; and displaying each existing business concept model resulting from the searching in a graphical representation on a display device of the computerized system for manipulation by a process designer using a business concept manipulation tool to form a specific business process model for the selected business process.

In another aspect, a computerized system for designing and modeling business processes for use in business process management is provided. In one embodiment, the computerized system includes a communication interface; at least one processor and associated memory; and a display device. The communication interface is configured to receive a description of a select business process in electronic form, wherein the select business process is associated with a domain-specific business type. The at least one processor is configured to process the description of the select business process using a natural language processing algorithm to parse one or more business activities from the description. The at least one processor is configured to use a search engine to search a business concept repository in a storage device for at least one existing business concept model related to each business activity of the one or more business activities parsed from the description, wherein the at least one processor is configured to run a business concept manipulation tool. The display device is configured to display each existing business concept model resulting from the searching in a graphical representation for manipulation by a process designer using the business concept manipulation tool to form a specific business process model for the select business process.

In yet another aspect, a non-transitory computer-readable medium storing program instructions that, when executed by at least one processor, cause a corresponding processor-controlled system to perform a method of generating a business process model. In one embodiment, the method includes receiving a description of a select business process in electronic form at a computerized system configured to design and model business processes for use in business process management, wherein the select business process is associated with a domain-specific business type; processing the description of the select business process at the computerized system using a natural language processing algorithm to parse one or more business activities from the description; searching a business concept repository in a storage device using a search engine for at least one existing business concept model related to each business activity of the one or more business activities parsed from the description, wherein the storage device is accessible to the computerized system; and displaying each existing business concept model resulting from the searching in a graphical representation on a display device of the computerized system for manipulation by a process designer using a business concept manipulation tool to form a specific business process model for the select business process.

### BRIEF DESCRIPTION OF THE DRAWINGS

FIG. 1 is a block diagram of an exemplary embodiment of a computerized system for designing and modeling business processes for use in business process management;

FIG. 2 provides a diagram depicting an exemplary parsing of a sentence in conjunction with generating a business process model using the exemplary computerized system of FIG. 1;

FIG. 3 provides a diagram depicting another exemplary parsing of a sentence in conjunction with generating a business process model using the exemplary computerized system of FIG. 1;

FIG. 4 provides a diagram depicting yet another exemplary parsing of a sentence in conjunction with generating a business process model using the exemplary computerized system of FIG. 1;

FIG. 5 is a flowchart of an exemplary embodiment of a process for generating a business process model;

FIG. 6 is a flowchart of an exemplary embodiment of a sub-process for modifying a graphical representation in conjunction with generating a business process model;

FIG. 7, in combination with FIG. 5, is a flowchart of another exemplary embodiment of a process for generating a business process model; and

FIG. 8 is a block diagram of another exemplary embodiment of a computerized system for designing and modeling business processes for use in business process management.

### DETAILED DESCRIPTION

This disclosure provides improvements to BP models that exploit business semantics by using domain-specific BPs. These semantically enhanced domain-specific processes enable an organization to have superior control on their processes and efficient process governance through a clear mapping of business semantics to the BPs. Also, with these domain-specific processes stored in a central repository, business concepts can be reused and consistency of the business concepts can be maintained in the repository. Furthermore, the system for BP design disclosed herein is able to query a process repository to find semantically similar processes or business concepts, recommend these processes to the user, and wait for user feedback. The resulting BP design may be a hybrid that reuses select portions of previous designs that can be stored in the repository for further reuse.

This disclosure provides a system for assisting a process designer to create/design a new process using natural language. The system also allows the process designer to get automatic process match recommendations through searches for semantically similar process present in an organization's process repository. Thus, a process designer is assisted by the system which is able to make use of the natural language text describing the new process. In a domain-specific BP modeling approach, the processes have the semantics about the business, process activities and the various automation (web services) used in the process as a process meta-data which makes managing the processes much easier in comparison to existing generic processes (i.e., creation, versioning, monitoring, governance and change management of processes).

Previous generic processes use natural language processing (NLP) for process creation. This disclosure extends the use of NLP to domain-specific BPM by applying semantic text parsing, an intelligent business concept/activity search on a central repository, and consideration of user feedback to create a process from its description. The parser extracts the required objects (e.g., activities, actors, gateways, automation services) from the sentence; then the system checks the presence of these objects in the central repository, which contains information about various domain-specific processes and their components. These objects are arranged as a process and shown to a human process designer involved in modeling of the process so that he/she can edit the components (i.e., provide user feedback) and save the completed process to the repository for future reference and use.

The various embodiments of systems and methods for creation of domain-specific BP models using natural language text envisions bringing BP support to specific business units of an organization. This vision can make NLP capabilities an essential brick of domain-specific workbenches. For example, an NLP capability for designing processes could be provided as a part of domain-specific studios that would be useful to process consultants for process design. An advantage of this solution is that it brings the power of BPM closer to non-technical users so that they can use the natural language of their business domain to create and improve processes.

BPM is an important paradigm in today's enterprise solutions environment because it provides a high level of agility to business applications. BPM suites are complex software stacks that execute business activities and connect them to various enterprise resources, such as various legacy applications and services associated with the organization and its Service Oriented Architecture (SOA). The notion of business concepts and domain-specific BPs which have the semantics of the business and underlying services embedded into them have been previously introduced. For additional information on such business concepts and domain-specific BPs, see U.S. Pat. App. Publication No. 2016/0162816 to Suri et al. and U.S. Pat. App. Publication No. 2015/0046212 to Mos, the contents of which are fully incorporated herein by reference.

Domain-specific processes are quite different from the classical BPs because they make use of ‘business concepts’ which have semantics about a real business activity that takes place in an organization, such as ‘book a hotel.’ Domain-specific processes use the notion of ‘concept probes’ to monitor and govern the business activities executing in a BPM engine. Domain-specific processes can be stored in a central repository which could be visualized as any normal process repository having a layer on top of it for managing the complexities of a domain-specific BP. The central repository enables the users to effectively govern their processes, manage versions, link the activities to services, and store this information as meta-data for the processes. The central repository also provides a summary about a ‘business concept’ on the fly. For example, the central repository could tell how many processes a specific business concept is used in, how many times it has been instantiated, its average run time, etc.

The various embodiments of systems and methods disclosed herein focus on designing a process, rather than on execution of the process. The design phase is as important as the execution phase for an organization involved in making use of BPM tools. In any BP (generic or domain-specific), the first and foremost step is to design the process in a language that is understood and is executable by the process engine in which that process would be executing. Today, many state of the art BPM tools use the BPMN specification to design a process. There are many other methods to design the processes but we would like to keep our focus on the state-of-the-art standards. Normally, BPMN 2.0 process models could be serialized in BPMN 2.0 XML, where the XML file contains both the model semantics as well as the diagram-interchange information. Many open source tools and integrated development environments (IDEs), such as Eclipse, provide packages that understand the BPMN standards and help the process designers to design such processes using a graphical interface. Eclipse is an IDE that was developed by the Eclipse Foundation. The Eclipse IDE is part of an Eclipse software development kit (SDK) which is free and uses open-source software released under a public license.

Such graphical IDEs may simplify the process creation, but a user generally designs the process from scratch using such IDEs. If the designer is a new person in an organization with less experience or if a consultant goes to meet a client and has to create a new process on the fly there are significant inefficiencies or even impossible scenarios to deal with. Even if the organization makes proper use of process repositories, the user has to know about the pre-existence of various processes or would have to find a similar process by searching the process repository of his organization (publically available repository in some cases). In such a situation, finding a suitable process is limited to the search capabilities of such repository and the keywords the designer might use for his/her search. The company may have processes with various process variants and it could be a tedious task to manage such processes, especially for organizations that might have thousands of processes running for global market coverage (e.g., some bank have to deal with variations in a loan approval process across different locations). Thus, in such scenarios, if a user/designer needs to create or re-use a process it could be time consuming, difficult, or even impossible to accomplish within realistic time and budget constraints.

This disclosure presents a solution to the research problem that assists in the creation of a domain-specific BP based on the process description (text in natural language) to help design a process in a faster and easier manner. In other words, this disclosure combines the power of NLP and searching techniques for use in the BPM area and assists the user during the process designing phase. The fact that processes are designed using domain-specific concepts brings a unique opportunity for NLP application as there is significantly less ambiguity about the meaning of the text than if the processes were to be generic for any domain. The help comes from the concept repository which naturally steers the understanding of the text.

In general, a domain-specific BP is a collection of ‘domain-specific’ business concepts or business activities (e.g., ‘book a flight’ is specific to travel domain) which are required to execute in a specific order (sequentially or in parallel) by an executor (i.e. a human actor or an automated service). An actor (e.g., an applicant, a manager, a clerk, etc.) has a specific role in a process that he/she could take up to complete a task. Some business activities might also require complex functionalities or services which could be constructed to avoid use of human assistance and could be done automatically. These automation services could be a weather check, inventory check, or automated acknowledgement mails to be sent by mail server. For example, in the past there would be a system administrator to change your password, but now changing passwords can be done automatically.

Normally, a process designer or a team of designers who are competent to create a process express the process description in text form. This text form is created after interviews and a requirement analysis by experts in various domains, such as travel, healthcare, banking, etc. The initial job of the process designer is to create a process, usually expressed in graphical form, that conforms to the process description. The graphical form of the process is verified by the experts to determine if it matches the requirements. In theory, before starting to create a new process a process designer should be able to efficiently search all the process samples that are present in an organization. But in the real world there are several issues, first many organizations do not use a central repository that would be consistent and would have properly versioned processes. Additionally, there can be thousands of processes with several versions. Moreover, processes might have activity labels that would be semantically similar to the activity labels to be created from the given process description. These activity labels may require advanced searching methods from a central repository (e.g., ‘book a flight’ and ‘book a plane’ are semantically similar). There should be some help provided to a process designer to find a semantically similar process from the repository. These circumstances and concerns provide motivation to use NLP techniques for assisting process designer to design processes.

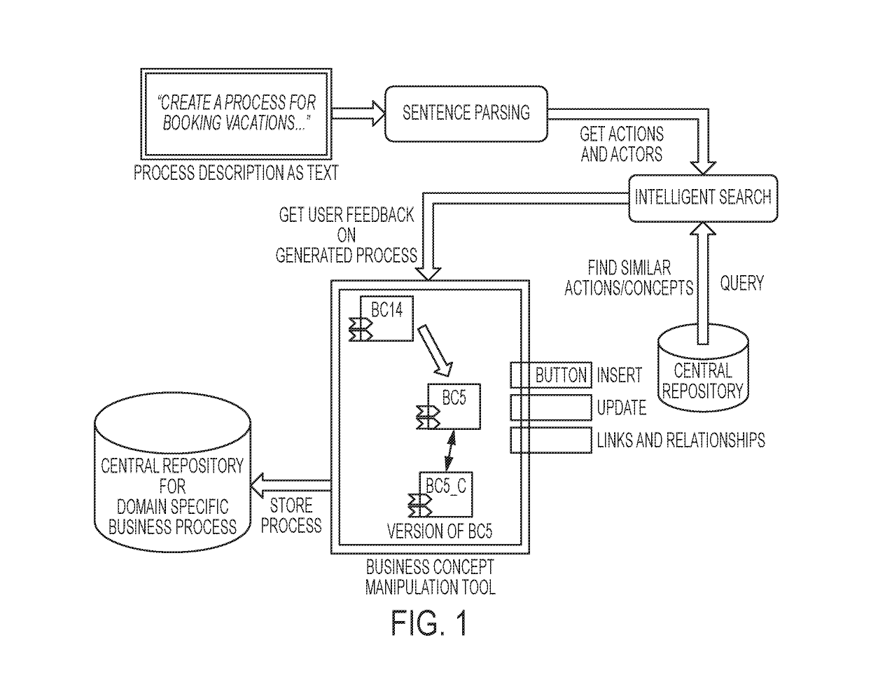

With reference to FIG. 1, an exemplary mechanism though which a textual process description could be used to generate a process model starts with a process description in text form. While even though there is inherent ambiguity in use of natural languages, such as English or French, the mechanism can be used to assist the user by providing him/her with a related design found in the repository and then, based on user feedback and/or interaction, the re-used process design can be edited and stored in the repository for future reference and re-use.

The textual process description could be taken from a user as a file or by creating a simple GUI with a text field. The text can then be fed to a sentence parsing component. The sentence parser processes each sentence to find ‘events’ (i.e. special types of verbs or, in BPM terminology, ‘business activities’) which might be present in the sentence. For example, special types of verbs could be identified for their specific relevance and use in a particular business field or type of business activity. The sentence parser also finds actors associated with the events or, as they are called in BPM, the ‘roles.’ The roles could be taken up by human actors working on the activity. The roles could also be an automated service as mentioned above. The sentence parser could also recognize conditional statements, such as “if,” “then,” “else,” etc., which would be used to create gateways, such as “OR” or “AND” in a process flow.

Next, the system performs an intelligent search of the central repository for similar events/actions that might be present in the repository. The main reason for this is to help re-use and also to maintain a consistent system. The search could be done by using each action verb from the parsed sentence. At this stage, the system is not focused on the speed of creating the process, which depends on the quality of sentence, the quality of the parsing, and the speed of the search on the repository. As mentioned before, the central repository could be considered as any model repository which would have a separate domain-specific layer to manage the relationship and metadata about business concepts. The repository can handle domain-specific concepts. Thus, the system can use repositories with specific additions that can make them capable of managing domain-specific processes.

Once these actions have been extracted and the search for presence of similar actions (business activities or business concepts) from the repository is completed, the system provides the resulting similar actions to the user. The user/process designer would use some manipulation tool or a simple XML file to provide feedback on the process created and enrich the process model. The process designer would also have the capability to add links and relationship about the process and BP recommended to him/her to other processes in the system, in case he/she knows it from before. These relations could be stored as meta-data for the domain-specific processes in the repository. The system assisted user feedback is a useful feature to enrich any process model. For example, the user feedback can assist the system in creating better processes and addition of domain-knowledge that may not have been previously captured and presented to this system. Where the system might return that ‘book a flight to Grenoble’ and ‘book a flight to Zurich’ are similar, the user could provide his/her feedback saying that he wants to create a new business concept (activity) ‘book a flight to Grenoble’ which has a relationship to ‘book a flight to Zurich’ such that ‘book a flight to Grenoble’ is a version of ‘book a flight to Zurich’. Thus, the feedback mechanism can correct the process and keep the repository more consistent.

An exemplary embodiment is described to prove the feasibility of using NLP to create a simple process. One part of creating the simple process is to be able to identify events/actions and actors (i.e., process names) from the sentence. In more complicated process, gateways, such as “OR” and “AND” functions can be extracted from the text when “if,” “else,” and like words are detected in the sentence. However, the feasibility example is kept simple, without any gateways.

The exemplary process description is:
“Create a process for booking vacations. This process starts when a clerk books a hotel. After that, he books a flight.”

In classical NLP, parsing is a procedure for analyzing syntactic structure. Many kinds of parsing have been argued in the research field for different advantages. Popular choices include probabilistic context free grammar (PCFG) parsing and dependency parsing. For additional information on PCFG parsing, see Knudsen et al., RNA Secondary Structure Prediction using Stochastic Context-free Grammars and Evolutionary History, Bioinformatics, Vol. 15, No. 6, Oxford University Press, 1999, pp. 446-454, the contents of which are fully incorporated herein by reference. For additional information on dependency parsing, see Hays, Dependency Theory: A Formalism and some Observations, Memorandum RM-4087-PR, The Rand Corporation, July 1964, 47 pages, the contents of which are fully incorporated herein by reference. In this work, as we want to extract information, particularly on a semantic level, identifying actors and actions. The various embodiments disclosed herein may use a context categorical grammar (CCG) parser. For additional information on a CCG parser, see Steedman, Combinatory Grammars and Parasitic Gaps, Natural Language Theory 5, 1987, pp. 403-439, the contents of which are fully incorporated herein by reference.

CCG is a linguistic plausible grammar formalism which has a transparent interface between surface syntax and underlying semantic representation, including predicate-argument structure, quantification and information structure. CCG is used to exploit its predicate argument structure. The CCG syntactic category reflecting actors and actions is manually defined. This manual procedure is similar to previous work in open domain question answering using CCG. For additional information on open domain question answering, see Reddy et al., Large-scale Semantic Parsing without Question-Answer Pairs, Transactions of the Association for Computational Linguistics, Vol. 2, October 2014, pp. 377-392, the contents of which are fully incorporated herein by reference. Thus, creation of the BP includes parsing a sentence using CCG and extracting syntactic/semantic categories based on manually defined syntactic categories.

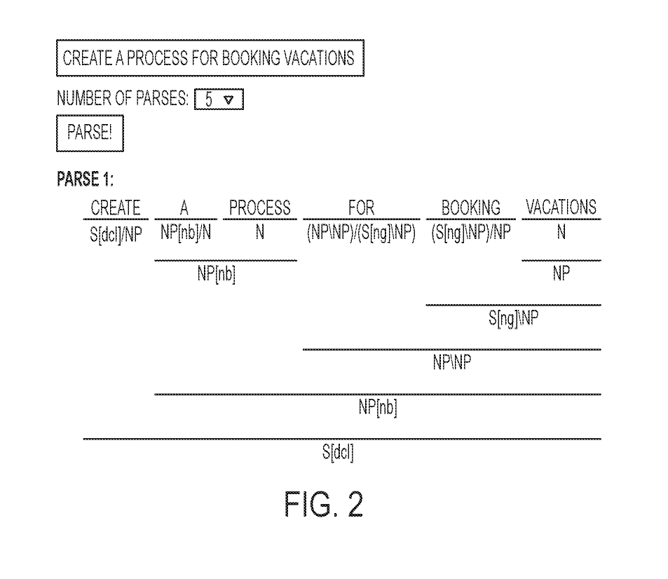

For example, all of the syntactic category ‘S[*]/NP,’ which corresponds to actions, can be extracted from the sentence. For extracting the actors from the sentence, the category ‘NP’ is extracted from the rest of the sentence. As shown in FIGS. 2-4, an open version of EasyCCG Parser Demo (see EasyCCG Parser, Http://4.easy-ccg.appspot.com/) can be used to extract the actions and actors from the exemplary sentence using the manually defined syntactic category. This shows a basic feasibility of the process for creating domain-specific BP models using natural language text. It is assumed that each sentence is parsed independently. Thus, there is no need to focus on an anaphora resolution. For additional information on anaphora resolutions, see Lappin et al., An Algorithm for Pronominal Anaphora Resolution, Computational Linguistics Journal, Vol. 20, Issue 4, December 1994, pp. 535-561, the contents of which are fully incorporated herein by reference. A unique identifier can be given to each sentence and actions to be found in the sentence can be assumed to follow a sequential order.

With reference to FIG. 2, the action name of “booking vacations” is identified for “creating a process.” This could lead to creating and using a domain-specific library for keywords, such as “create,” “make,” “process.” etc. and relate the domain-specific library to the action of “creating a process” with the name extracted from ‘S[*]/NP.’ In certain cases, it can be assumed that the first sentence describes the process name and that action can be extract from the sentence and cast it into the process name.

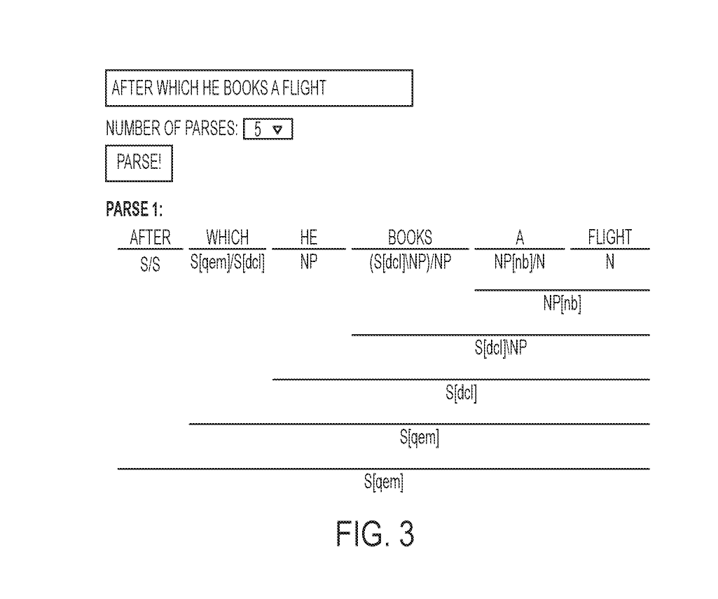

With reference to FIG. 3, parsing of the second sentence is shown and results in identifying two events (i.e., ‘start’ and ‘books a hotel’) and an actor (i.e., ‘clerk’).

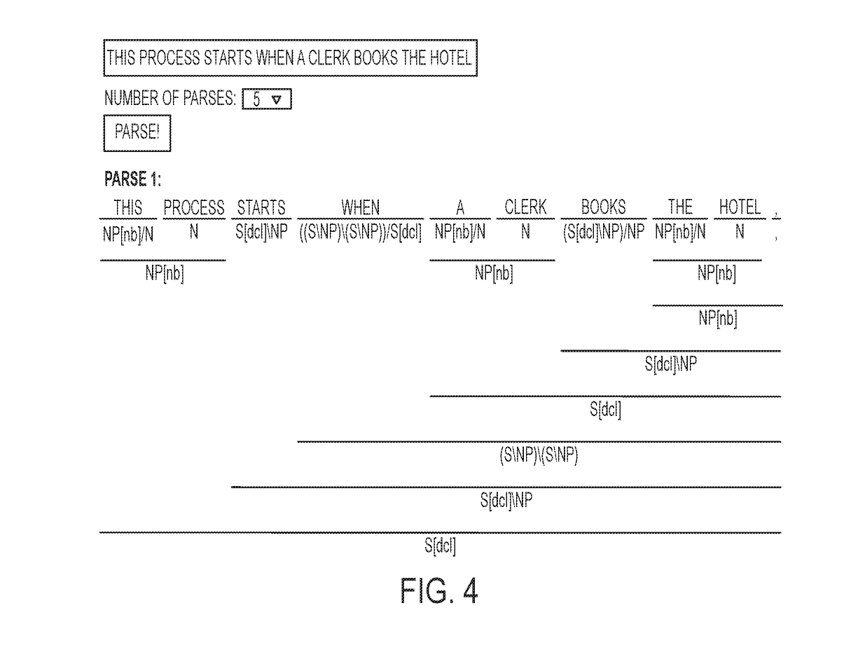

With reference to FIG. 4, ‘books a flight’ can be extracted as ‘S[*]/NP’ (i.e., action) and ‘he’ as the NP (i.e., actor) in a sentence that came after the second sentence from which an NP (i.e., clerk) was extracted. Thus, the NP of second and third sentences are the same person (i.e., clerk, without going deep into anaphora resolution).

The ‘Intelligent Search’ component is implemented because there is large variability of natural language expressions expressing the same idea. Accordingly, the intelligent search component can employ distributional semantics to natural language expressions to focus the search on BPM. For additional information on exemplary techniques for distributional semantics, see Mikolov et al., Efficient Estimation of Word Representations in Vector Space, arXiv, Sep. 7, 2013, 12 pp. and Pennington et al., Glove: Global Vectors for Word Representation, Proceedings of the 2014 Conference on Empirical Methods in Natural Language Processing, Oct. 25-29, 2014, Vol. 14, pp. 1532-1543, the contents of which are fully incorporated herein by reference.

Through the use of distributional semantics, the words are represented by real vectors that capture the semantics of the words. These representations are leveraged to do the intelligent search. After receiving a natural language expression, each word is represented by its distributional representation using the Glove algorithm described in Pennington. The distributional representations of each word in the expression are summed to create a semantic representation of the received natural language expression. The same procedure was performed for the business concepts (activities) already present in the central repository. The semantic representations of the natural language expressions in the central repository can be cached because these representations may be used often. Then, after comparison of the received and present semantic representations, the activity/concept nearest to the received natural language expression is returned from the central repository. The comparison may be based on calculating the distance between the received and present semantic representations using cosine similarity.

In an exemplary scenario, suppose there are four actions/business concepts in the repository. The exemplary four actions/business concepts include <book flight>, <book hotel>, <enter user information>, and <generate summary>. In the parsing section, the actions ‘books a hotel’ and ‘books the flight’ are extracted for this scenario. Thus, when the search strategy is used to search the BP repository, the search results could easily propose to the user that <book hotel> and <book flight> are present in the repository.

The use of a distributional semantics algorithm on natural language expressions provides an advanced process design that can detect similar semantics even if the words in the natural language expressions are quite different. Current BPM tools cannot match or relate natural language expressions that use different words, but have the same or similar meaning. In another exemplary scenario, ‘books a plane’ was extracted by the parsing section. In this scenario, there is not exact word matching between ‘books a plane’ and ‘book flight.’ Nevertheless, the search strategy finds ‘book flight’ as a match to ‘books a plane’.

With reference again to FIG. 1, the BP manipulation tool can be implemented as a graphical tool able to visualize and manipulate various relationships between business concepts. The graphical tool could be based on commercially available software development tools, such as Eclipse IDE or NetBeans. NetBeans is a software development platform by Sun Microsystems (now owned by Oracle Corporation). The graphical tool could open and edit files. For example, the graphical tool could add objects resulting from the intelligent search or otherwise proposed by the search system. Thus, the graphical tool could be used to edit processes, business activities, create links between various activities, and store the corresponding data file in a designated portion of the central repository for future use.

The various embodiments systems and methods for developing BP models combines domain-specific BPM with natural language parsing and advanced searching techniques using distributional semantics. Further embodiments include a provision for user feedback about the process and a corresponding process update cycle. While existing BP design methods focus on manual process design by a user, the embodiments disclosed herein introduce assisting such process designers to enable design of processes in an easier and faster way along with the possibility of reuse of other previously designed processes or at least portions of such processes that are known by and accessible to the designer and/or the organization.

The combination of a BPM framework, tools, and applications with NLP capabilities are not currently used in the generic BPM field or in domain-specific BPM. Some research initiatives, such as inubit Labs' Text2Process (see a YouTube demonstration https://www.youtube.com/watch?v=ISxQzDwe_-0), use NLP to generate BPMN process models from written text. However, inubit Labs, acquired by Bosch, merely uses generic processes. Inubit Labs did not consider using a central repository to re-use previously generated processes or the option for user feedback and process revisions.

The various embodiments of systems and methods disclosed herein advance work in the process management field, especially domain-specific BPM, because they enable the use of NLP techniques in BPM. These NLP techniques can be extended to support voice commands. The BPM tool disclosed herein could enable a process consultant to go to his client, take the requirements and in a few minutes create a process that otherwise might take a lot of time. The process consultant could display the process to his clients and demonstrate how such processes could be used in the client's organization. A voice-to-text layer can be added to the embodiments disclosed herein and integrated to use the resulting text with the NLP techniques. The resulting tool could assist a consultant going to meet his clients in being able to design the process while the clients are speaking. Today, a process consultant has to take the process description and design the process manually without much automated assistance from the system. Another advantage of the embodiments disclosed herein is that the system can be configured to running processes involved in various business domains, such as healthcare, transportation, and finance, by adding semantics processing of those specific business fields into the system.

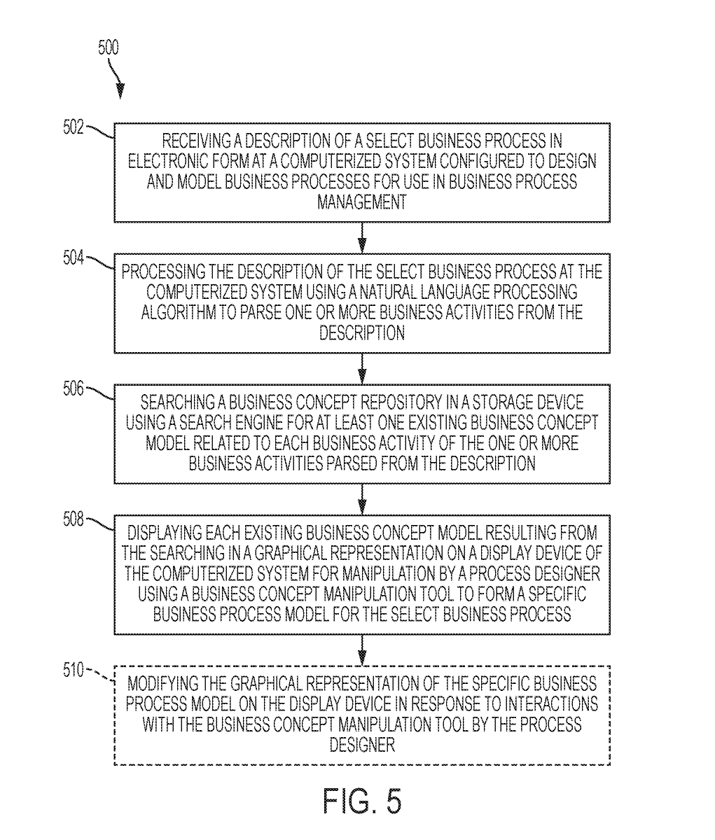

With reference to FIG. 5, an exemplary embodiment of a process 500 for generating a business process model begins at 502 where a description of a select business process in electronic form is received at a computerized system configured to design and model business processes for use in business process management. The select business process is associated with a domain-specific business type. For example, the select business process may be received in a text file or any suitable electronic form that can be converted or otherwise manipulated into a text file with recognizable characters. Next, the description of the select business process is processed at the computerized system using a natural language processing algorithm to parse one or more business activities from the description (504). At 506, a business concept repository in a storage device is searched using a search engine for at least one existing business concept model related to each business activity of the one or more business activities parsed from the description, wherein the storage device is accessible to the computerized system. Next, each existing business concept model resulting from the searching is displayed in a graphical representation on a display device of the computerized system for manipulation by a process designer using a business concept manipulation tool to form a specific business process model for the select business process (508). If the graphical representation depicts a model that is suitable for the select business process, generation of the model is complete. However, typically the depicted model will need to be edited or will at least need some tailoring. If so, at 510, the graphical representation of the specific business process model on the display device is modified in response to interactions with the business concept manipulation tool by the process designer.

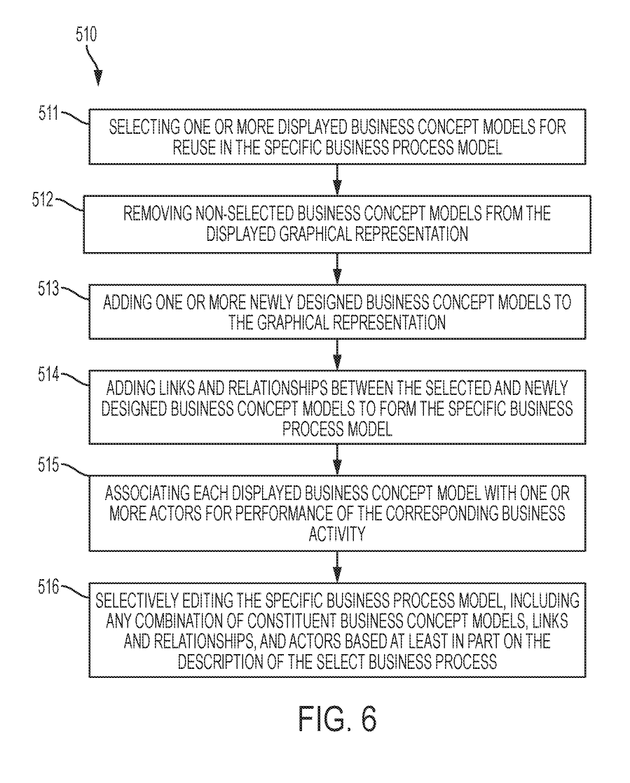

With reference to FIG. 6, in another embodiment of the process 500, modifying the graphical representation (510) includes any suitable combination of i) selecting one or more displayed business concept models for reuse in the specific business process model (511), ii) removing non-selected business concept models from the displayed graphical representation (512), iii) adding one or more newly designed business concept models to the graphical representation (513), iv) adding links and relationships between the selected and newly designed business concept models to form the specific business process model (514), v) associating each displayed business concept model with one or more actors for performance of the corresponding business activity (515), and vi) selectively editing the specific business process model, including any combination of constituent business concept models, links and relationships, and actors based at least in part on the description of the select business process (516).

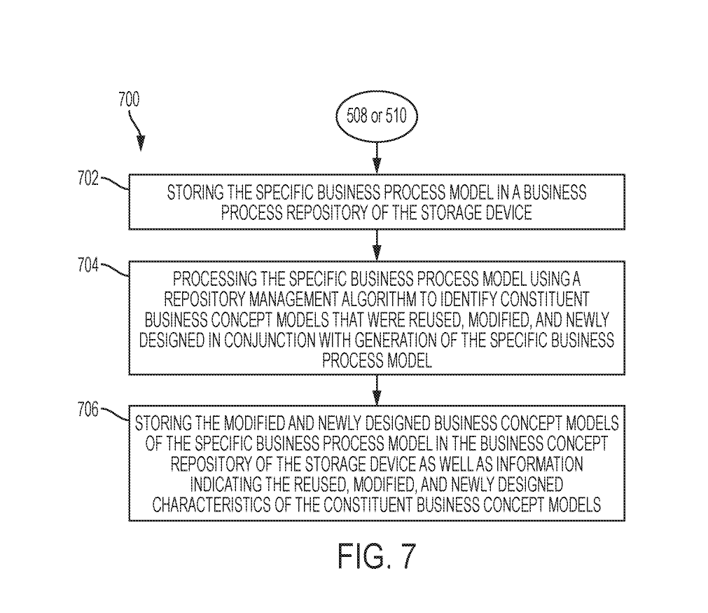

With reference to FIGS. 5 and 7, another exemplary embodiment of a process 700 for generating a business process model includes the process 500 of FIG. 5 and continues from 508 or 510 to 702 where the specific business process model is stored in a business process repository of the storage device. Next, the specific business process model is processed using a repository management algorithm to identify constituent business concept models that were reused, modified, and newly designed in conjunction with generation of the specific business process model (704). At 706, the modified and newly designed business concept models of the specific business process model are stored in the business concept repository of the storage device as well as information indicating the reused, modified, and newly designed characteristics of the constituent business concept models.

With reference again to FIG. 5, in still another embodiment, the process 500 also includes receiving information identifying the domain-specific business type for the select business process in electronic form at the computerized system. The natural language processing algorithm is configured to recognize the domain-specific business type and the description is parsed based at least in part on the domain-specific business type such that the one or more business activities resulting from the parsing are associated with the domain-specific business type. The search engine is configured to recognize the domain-specific business type and the searching of the business concept repository is based at least in part on the domain-specific business type such that each existing business concept model resulting from the searching is associated with the domain-specific business type. The business concept manipulation tool is configured to recognize the domain-specific business type and the specific business process model formed by the business concept manipulation tool is associated with the domain-specific business type.

In still yet another embodiment of the process 500, the natural language processing algorithm is configured to detect the domain-specific business type associated with the select business process and the description is parsed based at least in part on the domain-specific business type such that the one or more business activities resulting from the parsing are associated with the domain-specific business type. The search engine is configured to recognize the domain-specific business type and the searching of the business concept repository is based at least in part on the domain-specific business type such that each existing business concept model resulting from the searching is associated with the domain-specific business type. The business concept manipulation tool is configured to recognize the domain-specific business type and the specific business process model formed by the business concept manipulation tool is associated with the domain-specific business type.

In another embodiment of the process 500, the search engine is configured to detect the domain-specific business type associated with the select business process and the searching of the business concept repository is based at least in part on the domain-specific business type such that each existing business concept model resulting from the searching is associated with the domain-specific business type. The business concept manipulation tool is configured to recognize the domain-specific business type and the specific business process model formed by the business concept manipulation tool is associated with the domain-specific business type.

In yet another embodiment of the process 500, the natural language processing algorithm uses semantic rules associated with the domain-specific business type in conjunction with parsing the description such that the business activities resulting from the parsing are associated with the domain-specific business type and include semantically-equivalent forms of the business activities.

In still another embodiment of the process 500, the search engine uses semantic rules associated with the domain-specific business type in conjunction with searching the business concept repository such that the existing business concept models resulting from the searching are associated with the domain-specific business type and include semantically-equivalent forms.

In still yet another embodiment of the process 500, the business concept manipulation tool uses semantic rules associated with the domain-specific business type in conjunction with manipulation of the graphical image on the display device to form the specific business process model.

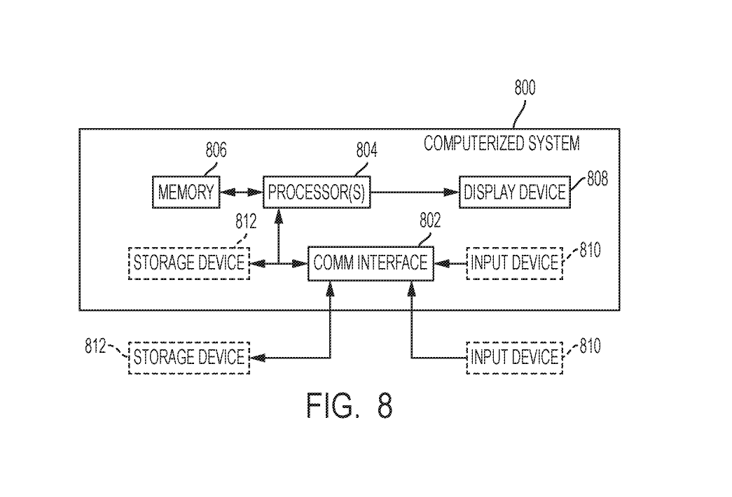

With reference to FIG. 8, a computerized system 800 for designing and modeling business processes for use in business process management includes a communication interface 802, at least one processor 804 and associated memory 806, and a display device 808. The communication interface 802 is configured to receive a description of a select business process in electronic form. The select business process is associated with a domain-specific business type. For example, the description may be received from an input device 810, a storage device 812, or any suitable device from which the description may be communicated or retrieved. The input device 810 may be a keyboard, a pointing device, or any suitable input device within the computerized system 800. Alternatively, the input device 810 may be a remote computing device, a mobile telephone, or any suitable external input device. The storage device 812 may be a hard drive, a memory card, a memory stick, or any suitable storage device within the computerized system 800. Alternatively, the storage device 812 may be a remote computing device, a server computer, or any suitable external storage device.

The at least one processor 804 is configured to process the description of the select business process using a natural language processing algorithm to parse one or more business activities from the description. The at least one processor 804 is configured to use a search engine to search a business concept repository in a storage device 812 for at least one existing business concept model related to each business activity of the one or more business activities parsed from the description. The storage device 812 may be internal or external. The storage device 812 with the business concept repository may be different from another storage device that may be used to store the description of the select business process. The at least one processor 804 is configured to run a business concept manipulation tool. The display device 808 is configured to display each existing business concept model resulting from the searching in a graphical representation for manipulation by a process designer using the business concept manipulation tool to form a specific business process model for the select business process.

In another embodiment of the computerized system 800, the at least one processor 804 is configured to modify the graphical representation of the specific business process model on the display device in response to interactions with the business concept manipulation tool by the process designer.

In another embodiment of the computerized system 800, the at least one processor 804 is configured to store the specific business process model in a business process repository of the storage device 812. The storage device 812 with the business process repository may be different from another storage device that may be used to store the description of the select business process. Likewise, storage device 812 with the business process repository may be different from another storage device used to store the business concept repository. The at least one processor 804 is configured to process the specific business process model using a repository management algorithm to identify constituent business concept models that were reused, modified, and newly designed in conjunction with generation of the specific business process model. The at least one processor 804 is configured to store the modified and newly designed business concept models of the specific business process model in the business concept repository of the storage device as well as information indicating the reused, modified, and newly designed characteristics of the constituent business concept models.

In yet another embodiment of the computerized system 800, the communication interface 802 is configured to receive information identifying the domain-specific business type for the select business process in electronic form. The natural language processing algorithm is configured to recognize the domain-specific business type and the at least one processor 804 is configured to parse the description based at least in part on the domain-specific business type such that the one or more business activities resulting from the parsing are associated with the domain-specific business type. The search engine is configured to recognize the domain-specific business type and the at least one processor 804 is configured to search the business concept repository based at least in part on the domain-specific business type such that each existing business concept model resulting from the searching is associated with the domain-specific business type. The business concept manipulation tool is configured to recognize the domain-specific business type and the specific business process model formed by the business concept manipulation tool is associated with the domain-specific business type.

In still another embodiment of the computerized system 800, the natural language processing algorithm is configured to detect the domain-specific business type associated with the select business process and the at least one processor 804 is configured to parse the description based at least in part on the domain-specific business type such that the one or more business activities resulting from the parsing are associated with the domain-specific business type. The search engine is configured to recognize the domain-specific business type and the at least one processor 804 is configured to search the business concept repository based at least in part on the domain-specific business type such that each existing business concept model resulting from the searching is associated with the domain-specific business type. The business concept manipulation tool is configured to recognize the domain-specific business type and the specific business process model formed by the business concept manipulation tool is associated with the domain-specific business type.

In still yet another embodiment of the computerized system 800, the search engine is configured to detect the domain-specific business type associated with the select business process and the at least one processor 804 is configured to search the business concept repository based at least in part on the domain-specific business type such that each existing business concept model resulting from the searching is associated with the domain-specific business type. The business concept manipulation tool is configured to recognize the domain-specific business type and the specific business process model formed by the business concept manipulation tool is associated with the domain-specific business type.

In another embodiment of the computerized system 800, the at least one processor 804 is configured to use semantic rules associated with the domain-specific business type in conjunction with using the natural language processing algorithm to parse the description such that the business activities resulting from the parsing are associated with the domain-specific business type and include semantically-equivalent forms of the business activities.

In yet another embodiment of the computerized system 800, the at least one processor 804 is configured to use semantic rules associated with the domain-specific business type in conjunction with using the search engine to search the business concept repository such that the existing business concept models resulting from the searching are associated with the domain-specific business type and include semantically-equivalent forms.

In still another embodiment of the computerized system 800, the at least one processor 804 is configured to use semantic rules associated with the domain-specific business type in conjunction with using the business concept manipulation tool to manipulate the graphical image on the display device to form the specific business process model.

With reference to FIGS. 5-8, various exemplary embodiments of non-transitory computer-readable medium storing program instructions that, when executed by at least one processor 804, cause a corresponding processor-controlled system (e.g., computerized system 800) to perform a method of generating a business process model. For example, various embodiments of the processor-controlled apparatus are described above with reference to FIG. 8. Various embodiments of the method of generating a business process model are described above with reference to FIGS. 5-7. In other words, the program instructions of the various exemplary embodiments of non-transitory computer-readable medium are defined by any suitable combination of the processes 500, 600, 700 described above with reference to FIGS. 5-7. Similarly, the at least one processor 804 and the processor-controlled system associated with the various exemplary embodiments of non-transitory computer-readable medium are defined by any suitable combination of the computerized system 800 described above with reference to FIG. 8.

It will be appreciated that variants of the above-disclosed and other features and functions, or alternatives thereof, may be combined into many other different computer platforms, computer applications, or combinations thereof. Various presently unforeseen or unanticipated alternatives, modifications, variations, or improvements therein may be subsequently made by those skilled in the art which are also intended to be encompassed by the following claims.

What is claimed is:

1. A method of generating a business process model, comprising:
receiving a description of a select business process in electronic form at a computerized system configured to design and model business processes for use in business process management, wherein the select business process is associated with a domain-specific business type;
processing the description of the select business process at the computerized system using a natural language processing algorithm to parse one or more business activities from the description;
searching a business concept repository in a storage device using a search engine for at least one existing business concept model related to each business activity of the one or more business activities parsed from the description, wherein the storage device is accessible to the computerized system; and
displaying each existing business concept model resulting from the searching in a graphical representation on a display device of the computerized system for manipulation by a process designer using a business concept manipulation tool to form a specific business process model for the select business process.

2. The method of claim 1, further comprising:
modifying the graphical representation of the specific business process model on the display device in response to interactions with the business concept manipulation tool by the process designer.

3. The method of claim 2, wherein the modifying the graphical representation includes at least one of the following:
selecting one or more displayed business concept models for reuse in the specific business process model;
removing non-selected business concept models from the displayed graphical representation;
adding one or more newly designed business concept models to the graphical representation;
adding links and relationships between the selected and newly designed business concept models to form the specific business process model;
associating each displayed business concept model with one or more actors for performance of the corresponding business activity; and
selectively editing the specific business process model, including any combination of constituent business concept models, links and relationships, and actors based at least in part on the description of the select business process.

4. The method of claim 1, further comprising:
storing the specific business process model in a business process repository of the storage device;
processing the specific business process model using a repository management algorithm to identify constituent business concept models that were reused, modified, and newly designed in conjunction with generation of the specific business process model; and
storing the modified and newly designed business concept models of the specific business process model in the business concept repository of the storage device as well as information indicating the reused, modified, and newly designed characteristics of the constituent business concept models.

5. The method of claim 1, further comprising:
receiving information identifying the domain-specific business type for the select business process in electronic form at the computerized system;
wherein the natural language processing algorithm is configured to recognize the domain-specific business type and the description is parsed based at least in part on the domain-specific business type such that the one or more business activities resulting from the parsing are associated with the domain-specific business type;
wherein the search engine is configured to recognize the domain-specific business type and the searching of the business concept repository is based at least in part on the domain-specific business type such that each existing business concept model resulting from the searching is associated with the domain-specific business type;
wherein the business concept manipulation tool is configured to recognize the domain-specific business type and the specific business process model formed by the business concept manipulation tool is associated with the domain-specific business type.

6. The method of claim 1, wherein the natural language processing algorithm is configured to detect the domain-specific business type associated with the select business process and the description is parsed based at least in part on the domain-specific business type such that the one or more business activities resulting from the parsing are associated with the domain-specific business type;
wherein the search engine is configured to recognize the domain-specific business type and the searching of the business concept repository is based at least in part on the domain-specific business type such that each existing business concept model resulting from the searching is associated with the domain-specific business type;
wherein the business concept manipulation tool is configured to recognize the domain-specific business type and the specific business process model formed by the business concept manipulation tool is associated with the domain-specific business type.

7. The method of claim 1, wherein the search engine is configured to detect the domain-specific business type associated with the select business process and the searching of the business concept repository is based at least in part on the domain-specific business type such that each existing business concept model resulting from the searching is associated with the domain-specific business type;
wherein the business concept manipulation tool is configured to recognize the domain-specific business type and the specific business process model formed by the business concept manipulation tool is associated with the domain-specific business type.

8. The method of claim 1, wherein the natural language processing algorithm uses semantic rules associated with the domain-specific business type in conjunction with parsing the description such that the business activities resulting from the parsing are associated with the domain-specific business type and include semantically-equivalent forms of the business activities.

9. The method of claim 1, wherein the search engine uses semantic rules associated with the domain-specific business type in conjunction with searching the business concept repository such that the existing business concept models resulting from the searching are associated with the domain-specific business type and include semantically-equivalent forms.

10. The method of claim 1, wherein the business concept manipulation tool uses semantic rules associated with the domain-specific business type in conjunction with manipulation of the graphical image on the display device to form the specific business process model.

11. A computerized system for designing and modeling business processes for use in business process management, the computerized system comprising:
a communication interface;
at least one processor and associated memory; and
a display device;
wherein the communication interface is configured to receive a description of a select business process in electronic form, wherein the select business process is associated with a domain-specific business type;
wherein the at least one processor is configured to process the description of the select business process using a natural language processing algorithm to parse one or more business activities from the description;
wherein the at least one processor is configured to use a search engine to search a business concept repository in a storage device for at least one existing business concept model related to each business activity of the one or more business activities parsed from the description, wherein the at least one processor is configured to run a business concept manipulation tool;
wherein the display device is configured to display each existing business concept model resulting from the searching in a graphical representation for manipulation by a process designer using the business concept manipulation tool to form a specific business process model for the select business process.

12. The computerized system of claim 11, wherein the at least one processor is configured to modify the graphical representation of the specific business process model on the display device in response to interactions with the business concept manipulation tool by the process designer.

13. The computerized system of claim 11, wherein the at least one processor is configured to store the specific business process model in a business process repository of the storage device;
wherein the at least one processor is configured to process the specific business process model using a repository management algorithm to identify constituent business concept models that were reused, modified, and newly designed in conjunction with generation of the specific business process model;
wherein the at least one processor is configured to store the modified and newly designed business concept models of the specific business process model in the business concept repository of the storage device as well as information indicating the reused, modified, and newly designed characteristics of the constituent business concept models.

14. The computerized system of claim 11, wherein the communication interface is configured to receive information identifying the domain-specific business type for the select business process in electronic form;
wherein the natural language processing algorithm is configured to recognize the domain-specific business type and the at least one processor is configured to parse the description based at least in part on the domain-specific business type such that the one or more business activities resulting from the parsing are associated with the domain-specific business type;
wherein the search engine is configured to recognize the domain-specific business type and the at least one processor is configured to search the business concept repository based at least in part on the domain-specific business type such that each existing business concept model resulting from the searching is associated with the domain-specific business type;
wherein the business concept manipulation tool is configured to recognize the domain-specific business type and the specific business process model formed by the business concept manipulation tool is associated with the domain-specific business type.

15. The computerized system of claim 11, wherein the natural language processing algorithm is configured to detect the domain-specific business type associated with the select business process and the at least one processor is configured to parse the description based at least in part on the domain-specific business type such that the one or more business activities resulting from the parsing are associated with the domain-specific business type;
wherein the search engine is configured to recognize the domain-specific business type and the at least one processor is configured to search the business concept repository based at least in part on the domain-specific business type such that each existing business concept model resulting from the searching is associated with the domain-specific business type;
wherein the business concept manipulation tool is configured to recognize the domain-specific business type and the specific business process model formed by the business concept manipulation tool is associated with the domain-specific business type.

16. The computerized system of claim 11, wherein the search engine is configured to detect the domain-specific business type associated with the select business process and the at least one processor is configured to search the business concept repository based at least in part on the domain-specific business type such that each existing business concept model resulting from the searching is associated with the domain-specific business type;
wherein the business concept manipulation tool is configured to recognize the domain-specific business type and the specific business process model formed by the business concept manipulation tool is associated with the domain-specific business type.

17. The computerized system of claim 11, wherein the at least one processor is configured to use semantic rules associated with the domain-specific business type in conjunction with using the natural language processing algorithm to parse the description such that the business activities resulting from the parsing are associated with the domain-specific business type and include semantically-equivalent forms of the business activities.

18. The computerized system of claim 11, wherein the at least one processor is configured to use semantic rules associated with the domain-specific business type in conjunction with using the search engine to search the business concept repository such that the existing business concept models resulting from the searching are associated with the domain-specific business type and include semantically-equivalent forms.

19. The computerized system of claim 11, wherein the at least one processor is configured to use semantic rules associated with the domain-specific business type in conjunction with using the business concept manipulation tool to manipulate the graphical image on the display device to form the specific business process model.

20. A non-transitory computer-readable medium storing program instructions that, when executed by at least one processor, cause a corresponding processor-controlled system to perform a method of generating a business process model, the method comprising:
receiving a description of a select business process in electronic form at a computerized system configured to design and model business processes for use in business process management, wherein the select business process is associated with a domain-specific business type;
processing the description of the select business process at the computerized system using a natural language processing algorithm to parse one or more business activities from the description;
searching a business concept repository in a storage device using a search engine for at least one existing business concept model related to each business activity of the one or more business activities parsed from the description, wherein the storage device is accessible to the computerized system; and
displaying each existing business concept model resulting from the searching in a graphical representation on a display device of the computerized system for manipulation by a process designer using a business concept manipulation tool to form a specific business process model for the select business process.
